(19) United States
(12) Patent Application Publication
(10) Pub. No.: US 2013/0149146 A1
(43) Pub. Date: Jun. 13, 2013

(54) SHUFFLING CALIPER YAW ACTUATOR AND BRAKE SYSTEM

(71) Applicant: Timothy R. Sasseen, Carpinteria, CA (US)

(72) Inventor: Timothy R. Sasseen, Carpinteria, CA (US)

(73) Assignee: Continental Wind Power, Inc., Carpinteria, CA (US)

(21) Appl. No.: 13/403,392

(22) Filed: Feb. 23, 2012

Related U.S. Application Data
(60) Provisional application No. 61/569,121, filed on Dec. 9, 2011.

(51) Int. Cl. F03D 11/00; F03D 7/02

(52) U.S. Cl. 416/1; 416/9

(57) ABSTRACT

A yaw actuation and braking system and method for controlling a yaw position of a wind turbine nacelle with respect to a tower. A brake rotor may be rigidly connected to one of the tower and the nacelle. A first brake caliper may be disposed to selectively close upon the brake rotor. A first linear actuator may be coupled between the first brake caliper and the other of the tower and the nacelle.

### RELATED APPLICATION INFORMATION

This patent claims priority from the following provisional patent applications: Application No. 61/569,121 filed Dec. 9, 2011 entitled Wind Turbine.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to an actuator and brake system to control the yaw position of the nacelle of a wind turbine.

2. Description of the Related Art

Wind turbines commonly consist of a tower and a wind-driven rotor coupled to a generator contained within a nacelle mounted on top of the tower. In order to efficiently generate electrical power, the nacelle must be rotated such that the rotor is facing the up-wind direction. Thus wind turbines contain a yaw actuation system to rotate the nacelle as appropriate for the wind conditions. The yaw actuation system must rotate the nacelle at a low rate of speed, and hold the nacelle in a particular yaw orientation when yaw rotation is not desired. In order to reduce wear on motor and other rotating components, the nacelle of the wind turbine is not rotated to follow the wind direction unless there is a fairly gross misalignment.

A yaw system of a wind turbine commonly includes one or more motors and a controller for the motors. Each motor typically rotates the nacelle via a high ratio gear box coupled to a pinion and ring gears. A turbine controller may transmit control information to one or more motor controllers.

A dominant failure mode in yaw systems is excessive pinion/ring gear wear or tooth failure. Additionally, the high ratio gearboxes typically used are expensive. The ring and pinion gear are highly sensitive to misalignment during operation, and can be subjected to high wear rates when there is a strong predominant wind direction.

High yaw moments can occur both when yaw actuation is in motion and when it is stopped. For example, while the yaw system is rotating the nacelle, the wind direction may shift by a significant amount before the nacelle realigns. This shift in the wind direction causes unequal forces on either side of the rotor and tries to rotate the nacelle further out of alignment. Wind-driven yaw moments may be resisted by motor torque, which may require large motors. Alternatively, a yaw braking system may be provided in addition to, or as part of, the yaw actuation system. A set of brakes, such as caliper brakes, may be provided at the base of the nacelle to prevent undesired rotation of the nacelle with respect to the tower. These brakes are typically large and hydraulically driven.

### DESCRIPTION OF THE DRAWINGS

FIG. 1 is a depiction of a wind turbine.

FIG. 2 is a schematic diagram of a shuffling caliper yaw actuator and brake system.

FIG. 3 is an enlarged schematic diagram of portions of the yaw actuator and brake system of FIG. 2.

FIG. 4 is a schematic diagram of a control subsystem with a shuffling caliper yaw actuator and brake system.

FIG. 5 is a flow chart of a process for operating a shuffling caliper yaw actuator and brake system.

Throughout this description, elements appearing in figures are assigned three-digit reference designators, where the most significant digit is the figure number where the element is first introduced, and the two least significant digits are specific to the element. An element that is not described in conjunction with a figure may be presumed to have the same characteristics and function as a previously-described element having the same reference designator.

### DETAILED DESCRIPTION

### Description of Apparatus

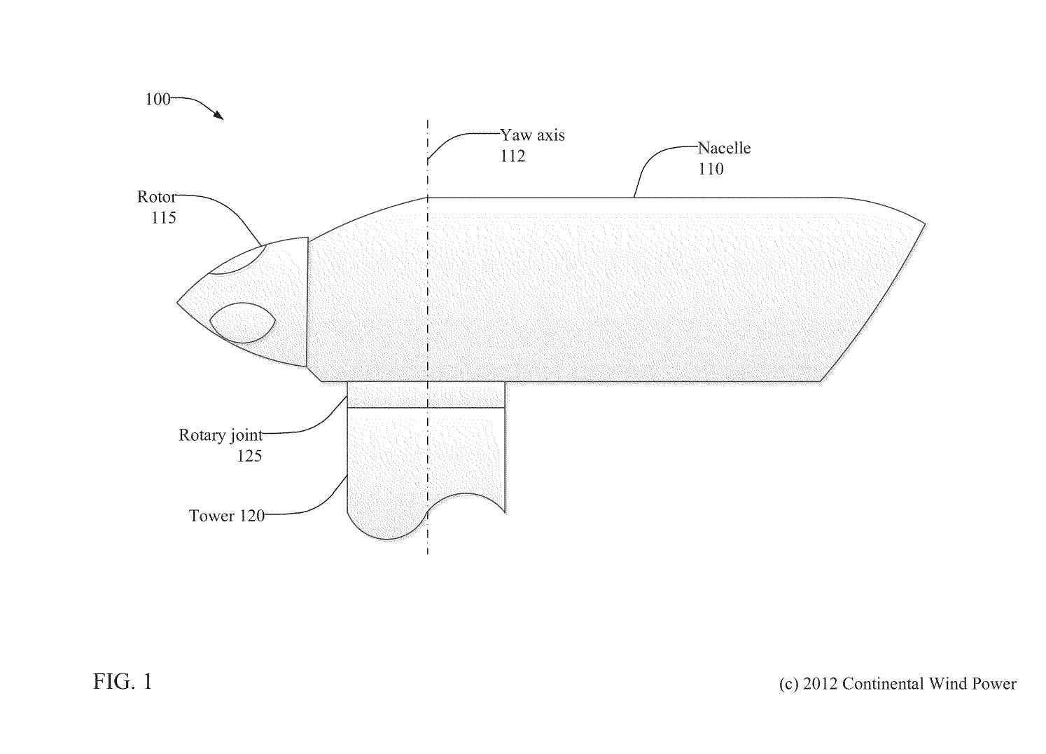

Referring now to FIG. 1, a wind turbine 100 may include a nacelle 110 coupled to the top of a tower 120 via a rotary joint 125. The nacelle 110 may enclose a generator system coupled to a rotor 115. Two or more blades (not shown) may extend from the rotor such that wind incident upon the blades causes the rotor 115 to rotate, thus driving the generator system to produce electrical power. While the rotary joint 125 is, for ease of description, visible in FIG. 1, the rotary joint 125 may be fully or partially enclosed within the nacelle 110 and/or the tower 120. The rotary joint 125 may include one or more bearings, bushings, or other mechanical components that allow the nacelle to rotate about an axis 112, which may be a vertical axis. The rotational position of the nacelle is commonly referred to as the “yaw position” or “yaw angle”, and the axis 112 will be referred to herein as the “yaw axis”

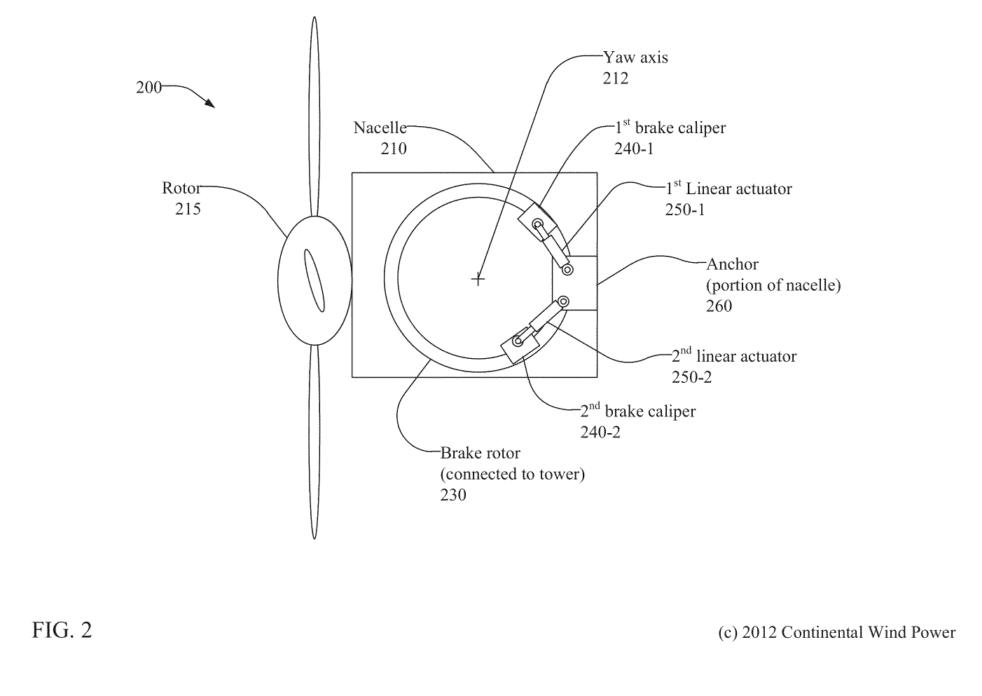

Referring now to FIG. 2, a wind turbine 200 may include a shuffling caliper yaw actuation and braking system. FIG. 2 is a partially schematic view of the wind turbine 200 from the top along the direction of a yaw axis 212. The relative position and movement of various parts of the wind turbine 200 will be described based upon this view. For example, the terms “clockwise” and “counter-clockwise” refer to the view of FIG. 2. A nacelle housing 210 and a rotor 215 of the wind turbine are shown schematically for reference.

The shuffling caliper yaw actuation and braking system may include a brake rotor 230 and two or more brake calipers, of which a first brake caliper 240-1 and a second brake caliper 240-2 are shown. In the example of FIG. 2, the brake rotor 230 may be an annular circular ring centered on a yaw axis 212 of the wind turbine 200. In this example, the first and second brake calipers 240-1, 240-2 are disposed along the inside of the annular-ring brake rotor 230. Alternatively, the brake rotor 230 may be a circular brake disc centered on the yaw axis. When the brake rotor 230 is a circular disc, brake calipers 240-1, 240-2 may be arranged about the circumference of the circular disc. An annular ring may be a preferred form for the brake rotor to allow cables carrying generated electricity from the nacelle to the ground to be routed through the center of the annular ring along the yaw axis.

In the example of FIG. 2, the brake rotor 230 may be rigidly connected to a tower (not visible) of the wind turbine 200, where the term “rigidly connected” means connected such that the brake rotor 230 may not translate or rotate with respect to the tower. Alternatively, the brake rotor 230 may be rigidly connected to the nacelle, in which case the brake calipers 240-1, 240-2 may be connected to the tower.

Each brake caliper, including the first brake caliper 240-1 and the second brake caliper 240-2, may include a respective brake actuator (not shown) to selectively cause the brake caliper to open or close. In its closed state, a brake caliper may grip the brake rotor 230 to inhibit or prevent rotation of the brake rotor 230 with respect to the brake caliper. Each brake actuator may be a pneumatic, hydraulic, electrical, electromechanical, or other actuator effective to open and close the respective brake caliper.

At least one of the two or more brake calipers may be connected to the nacelle 110 by a respective linear actuator. In the example of FIG. 2, the first brake caliper 240-1 is coupled to a first linear actuator 250-1 and the second brake caliper 240-2 is coupled to a second linear actuator 250-2. In this context, a linear actuator is a device that provides controllable linear motion, over a finite range, of a first end with respect to a second end. A linear actuator may be controllably extended to increase a linear distance between the first end and the second end or controllably retracted to reduce the linear distance between the first end and the second end. Although linear actuators 250-1 and 250-2 are illustrated in FIG. 2 as hydraulic cylinders, each linear actuator may be a hydraulic, pneumatic, electromagnetic, or electro mechanical device configured to selectively extend and retract along a linear axis. Representative linear actuators include hydraulic cylinders, pneumatic cylinders, solenoids, linear motors, and rotary motors coupled to a mechanism for converting rotary to linear motion (e.g. a lead screw). Each linear actuator 250-1, 250-2 may be disposed to adjust a position of the respective brake caliper 240-1, 240-2 with respect to a structure element of the nacelle 210, represented schematically in FIG. 2 as anchor 260.

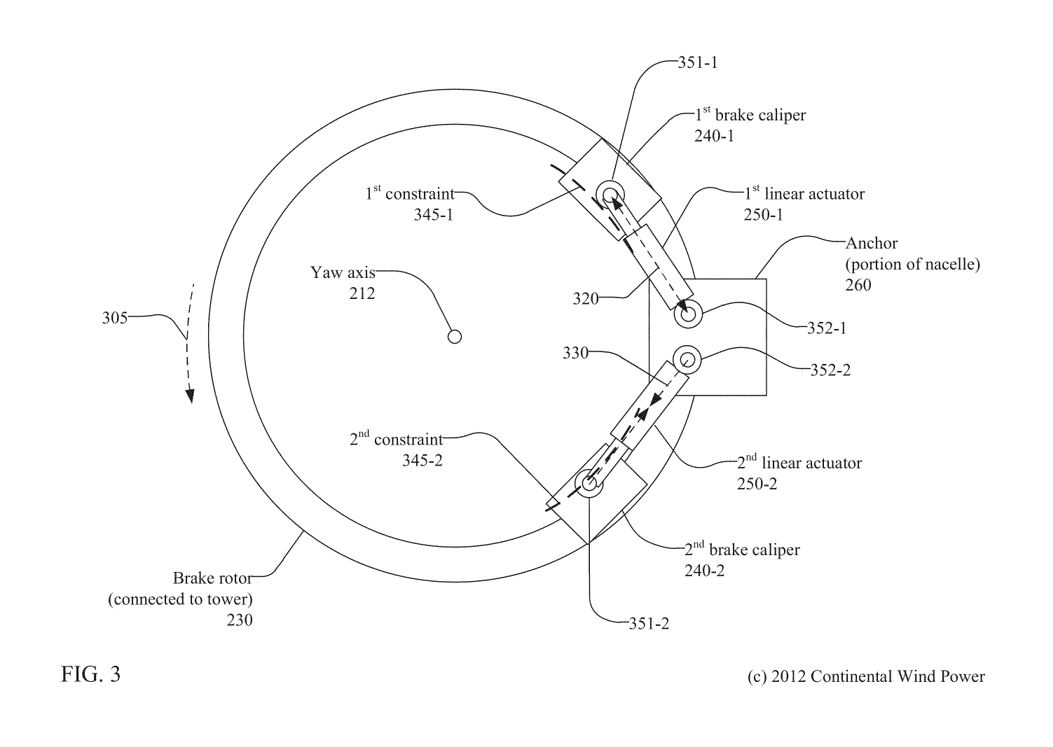

FIG. 3 provides and enlarged view, with additional detail, of the shuffling caliper yaw actuation and braking system of FIG. 2. Descriptions of elements provided in conjunction with FIG. 2 will not be repeated.

The first brake caliper 240-1 may be constrained in a manner that allows the first brake caliper 240-1 to move along a path equivalent to rotation about the yaw axis 212. The constraint of the first brake caliper 240-1 is illustrated schematically in FIG. 3 by a first dashed line 345-1. The dashed line 345-1 may represent, for example, a track attached to the structure of the nacelle, a slotted opening in the structure of the nacelle, or some other mechanism to constrain the first brake caliper 240-1 to move along a path equivalent to rotation about the yaw axis 212. The second brake caliper 240-2 may also be constrained in a manner that allows the second brake caliper 240-2 to move along a path equivalent to rotation about the yaw axis 212, as illustrated schematically in FIG. 3 by a second dashed line 345-2.

The first linear actuator 250-1 may be disposed to move the first brake caliper 240-1 with respect to the nacelle. The first linear actuator 250-1 may be coupled between the first brake caliper 240-1 and a structural element of the nacelle 210, represented schematically in FIG. 3 by the anchor 260, which is to say a first end 351-1 of the first linear actuator 350-1 may be pivotally coupled to the first brake caliper 240-1 and a second end 352-1 of the first linear actuator 250-1 may be pivotally coupled to the anchor 260. The anchor 260 represents the nacelle structure, but is not necessary a separate component of the nacelle. When the first linear actuator 250-1 is extended, or lengthened, the first brake caliper 240-1 may be caused to rotate about the yaw axis 212 in a counter-clockwise direction. When the first linear actuator 250-1 is retracted, or shortened, the first brake caliper 240-1 may be caused to rotate about the yaw axis 212 in a clockwise direction.

Similarly, the second linear actuator 250-2 may be disposed to move the second brake caliper 240-2 with respect to the structure of the nacelle. The second linear actuator 250-2 may be coupled between the second brake caliper 240-2 and the structure of the nacelle. A first end 351-2 of the second linear actuator 250-2 may be pivotally coupled to the second brake caliper 240-2. A second end 352-2 of the second linear actuator 250-2 may be pivotally coupled to the anchor 260. When the second linear actuator 250-2 is extended, or lengthened, the second brake caliper 240-2 may be caused to rotate about the yaw axis 212 in a clockwise direction. When the second linear actuator 250-2 is retracted, or shortened, the second brake caliper 240-2 may be caused to rotate about the yaw axis 212 in a counter-clockwise direction.

When one of the brake calipers 240-1, 240-2 is closed upon the brake rotor 230, extending or retracting the corresponding linear actuator 350-1, 350-2 will cause the nacelle to rotate with respect to the brake rotor 230 and thus with respect to the tower. For example, closing the first caliper 240-1 upon the brake rotor 230 and extending the first linear actuator 250-1, as indicated by the dashed arrow 320, will cause the first caliper 240-1 and the brake rotor 230 to rotated in a counter-clockwise direction, as indicated by the dashed arrow 305, with respect to the nacelle structure (which means the nacelle itself rotates in the clockwise direction with respect to the tower). Conversely, closing the first caliper 240-1 upon the brake rotor 230 and retracting the first linear actuator 250-1 will cause the nacelle to rotate in the counter-clockwise direction.

Similarly, closing the second caliper 240-2 upon the brake rotor 230 and retracting the second linear actuator, as indicated by the dashed arrow 330, will cause the second caliper 240-2 and the brake rotor 230 to rotated in a counter-clockwise direction, as indicated by the dashed arrow 305, with respect to the nacelle structure (which means the nacelle itself rotates in the clockwise direction with respect to the tower). Conversely, closing the second caliper 240-2 upon the brake rotor 230 and extending the second linear actuator 250-2 will cause the nacelle to rotate in the counter-clockwise direction.

The first and second calipers 240-1, 240-2 and the first and second linear actuators 250-1, 250-2 may be used to rotate the nacelle to any desired yaw position. In particular, first and second calipers 240-1, 240-2 and the first and second linear actuators 250-1, 250-2 may be used alternately to rotate the nacelle in small sequential increments. For example, to rotate the brake rotor 230 in the counter-clockwise direction with respect to the nacelle, as indicated by the dashed arrow 305, the first brake caliper 240-1 may be closed upon the brake rotor 230 and the second caliper 240-2 may be opened. Both linear actuators 250-1, 250-2 may then be extended, with the extension of the first linear actuator 250-1 forcing the brake rotor 230 to rotate incrementally. The first brake caliper 240-1 may then be opened, the second brake caliper 240-2 may be closed, and both linear actuators 250-1, 250-2 may be retracted. The retraction of the second linear actuator 250-2 may force, via the second brake caliper 240-2, the brake rotor 230 to rotate incrementally. These actions may be repeated to cause continuous, or nearly continuous, rotation of the brake rotor 230 with respect to the nacelle structure. Alternating the first and second linear actuators to rotate the brake rotor 230 in a series of incremental steps is referred to herein as “shuffling”.

Shuffling may be performed in full steps, in which the linear actuators are extended or retracted over their full range of motion on each step. Shuffling may be performed in fractional steps, in which the linear actuators are extended or retracted only a portion of their range of motion. In particular, when rotating the nacelle to a new yaw position, the final step may be a fractional step to place the nacelle is exactly the desired yaw position.

The yaw position of the nacelle may be maintained against wind-induced yaw moments by closing both brake calipers 240-1, 240-2 upon the brake rotor 230 and holding the lengths of the linear actuators fixed. Each linear actuator 250-1, 250-2 may incorporate a hard mechanical stop at one or both extremes of its range of travel. Each linear actuator 250-1, 250-2 may be extended or retracted against a hard stop before closing the respective brake caliper 240-1, 240-2 onto the brake rotor 230.

The shuffling caliper yaw actuation and braking system shown in FIG. 2 and FIG. 3 is exemplary and other configurations of a shuffling caliper yaw actuation and braking system are possible. In particular, while the shuffling caliper yaw actuation and braking system of FIG. 2 and FIG. 3 is configured with the brake rotor 230 attached to the tower and the brake calipers 240-1, 240-2 and linear actuators 250-1, 250-2 coupled to the nacelle, the converse is possible. A rotor or brake disc may be attached to the nacelle and the brake calipers and linear actuators may be coupled to and disposed within the tower.

A shuffling caliper yaw actuation and braking system may use more than two brake calipers and more than two linear actuators. When more than two linear actuators are present, they may be used in sequence or in sequential/parallel combinations to rotate a nacelle about a yaw axis. A shuffling caliper yaw actuation and braking system may include as few as one linear actuator and two brake calipers. In this case, a linear actuator coupled to a first brake caliper may be used to cause nacelle rotation in discontinuous steps, and a second brake shoe may be used to hold the nacelle in position while the linear actuator resets between steps.

The shuffling caliper yaw actuation and braking system of FIG. 2 and FIG. 3 has two brake calipers and two linear actuators arranged in what may be term a push-pull configuration since the first brake caliper and linear actuator push the nacelle in a clockwise direction (i.e. the nacelle moves as the linear actuator is extended) and the second brake caliper and linear actuator pull (i.e. the nacelle moves as the linear actuator is retracted) the nacelle in the clockwise direction. The brake calipers and linear actuators of a shuffling caliper yaw actuation and braking system may be configured such that all of the linear actuators push or pull in the same directions.

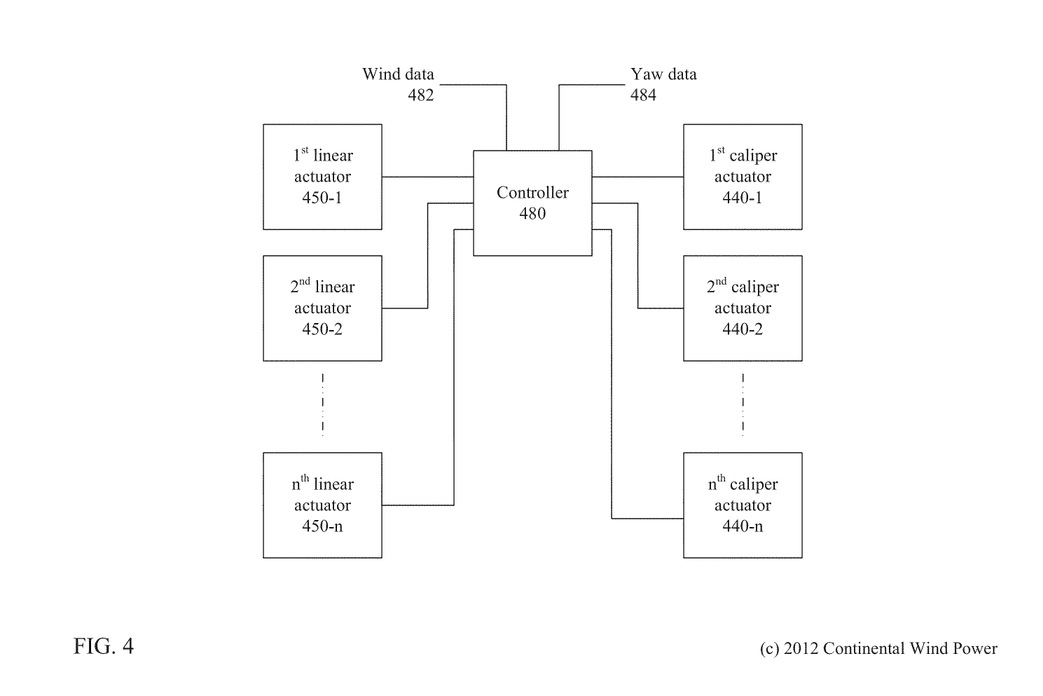

FIG. 4 is a block diagram of a control subsystem for a shuffling caliper yaw actuator and brake system. A controller 480 may receive wind data 482 indicating a direction and velocity of incident wind and yaw data 484 indicating a present yaw position of the nacelle of a wind turbine. The wind data 482 and the yaw data 484 may be received from sensors on or couple to the wind turbine. The controller 480 may determine a desired yaw position for the nacelle of a wind turbine based on the wind data. The controller 480 may then compare the desired yaw position with the current yaw position to determine the necessary rotation of the nacelle. The controller may provide commands to a plurality of caliper actuators 440-1, 440-2 . . . 440-n and a plurality of linear actuators 450-1, 450-2, 450-n to rotate the nacelle to the desired yaw position.

The controller 480 may include hardware and software for providing the functionality and features described herein. The controller 480 may include one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). The hardware and firmware components of the controller 480 may include various specialized units, circuits, software and interfaces for providing the functionality and features described here. The processes, functionality and features may be embodied in whole or in part in software which operates on one or more processors and may be in the form of firmware, an application program, an applet (e.g., a Java applet), a browser plug-in, a COM object, a dynamic linked library (DLL), a script, one or more subroutines, or an operating system component or service. The hardware and software and their functions may be distributed such that some functions are performed by a processor and others by other devices. For example, the controller 480 may includes a common processor or processor unit to determine appropriate commands for the linear actuators and caliper actuators and individual driver circuits for each actuator. The controller 480 may be physically distributed. For example the common processor or processor unit may be disposed at a central location and individual driver circuits may be disposed proximate the respective actuators.

Software instructions for providing some or all of the functionality described herein may be stored on a machine readable storage media in a storage device (not shown) included with or otherwise coupled or attached to the controller 480. These machine readable storage media include, for example, magnetic media such as hard disks, optical media such as compact disks (CD-ROM and CD-RW) and digital versatile disks (DVD and DVD±RW); flash memory cards; and other storage media. As used herein, the term “storage media” does not encompass transitory media such as propagating signals and waveforms. Storage devices include hard disk drives, DVD drives, flash memory devices, and others.

Description of Methods

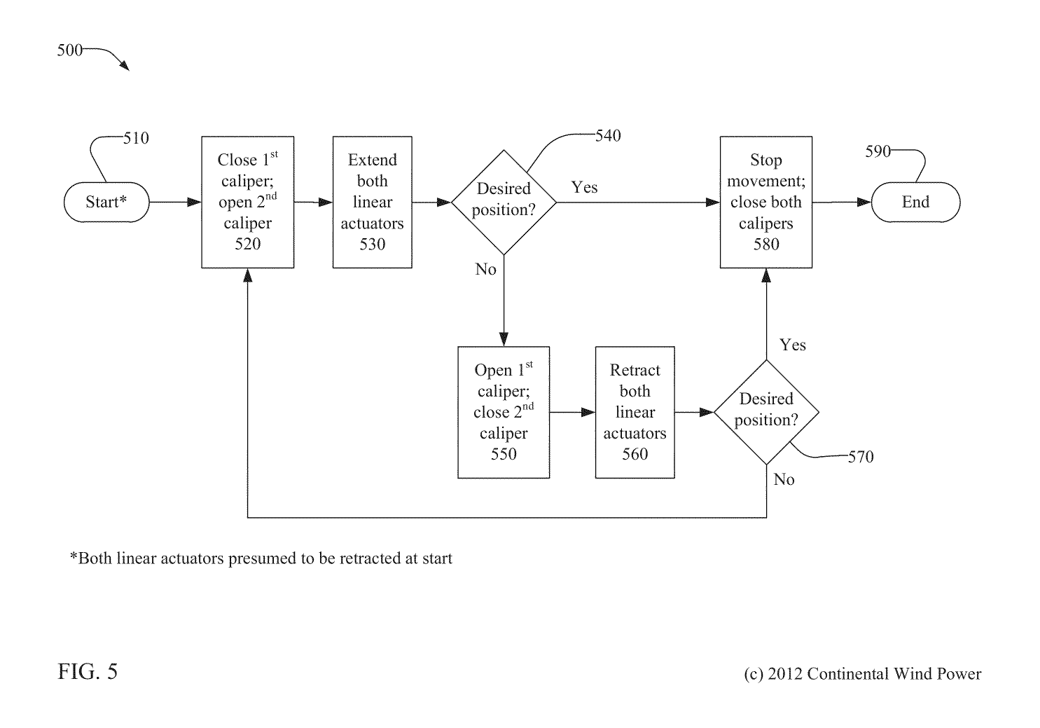

FIG. 5 is a flow chart of a process 500 of operating a shuffling caliper yaw actuation and braking system. Specifically, FIG. 5 is a flow chart of a process for operating a shuffling caliper yaw actuation and braking system configured as shown in FIG. 2 and FIG. 3 to cause a nacelle to rotate by a desired amount in the clockwise direction.

The process 500 starts at 510 when a controller, such as the controller 480, determines a new desired yaw position that requires a nacelle to rotate in the clockwise direction. For ease of description, it is assumed that both linear actuators are in their fully retracted positions at 510.

At 520, a first brake caliper is closed upon a brake rotor and a second brake caliper is opened. At 530, first and second linear actuators respectively coupled to the first and second rotors are extended. Extending the first linear actuator pushes, via the first brake caliper and the brake rotor, the nacelle in the clockwise direction. Extending the second linear actuator positions the second brake caliper for the next actions of the process.

At 540, a determination is made if the nacelle has been rotated to the desired position. The determination at 540 may be performed in parallel with extending the linear actuators at 530. In this case, a determination may be made that the nacelle has reached the desired position after the actuators have been extended only a fraction of their range of travel. If a determination is made that the nacelle has reached the desired position, the movement of the nacelle may be stopped and both calipers may be closed upon the brake rotor at 580 to hold the nacelle in the desired position. The process 500 may then end at 590.

When a determination is made at 540 that the nacelle has not yet reached the desired position after the actuators have been extended to their full length at 530, the first brake caliper may be opened and the second brake caliper may be closed at 550. At 560, both linear actuators may be retracted. Retracting the second linear actuator pulls, via the second brake caliper and the brake rotor, the nacelle in the clockwise direction. Retracting the first linear actuator positions the first brake caliper for the next actions of the process.

At 570, a determination is made if the nacelle has been rotated to the desired position. The determination at 570 may be performed in parallel with retracting the linear actuators at 560. In this case, a determination may be made that the nacelle has reached the desired position after the actuators have been retracted only a fraction of their range of travel. If a determination is made that the nacelle has reached the desired position, the movement of the nacelle may be stopped and both calipers may be closed upon the brake rotor at 580 to hold the nacelle in the desired position. The process 500 may then end at 590.

When a determination is made at 570 that the nacelle has not yet reached the desired position after the linear actuators have been retracted to their minimum length at 560, the actions from 520 to 570 may be repeated cyclically until the nacelle reaches the desired yaw position.

While the process 500 is specific to clockwise rotation using the shuffling caliper yaw actuation and braking system of FIG. 2 and FIG. 3, methods of operating other shuffling caliper yaw actuation and braking system configurations can be easily derived from the process 500. For example, reversing the states of the first and second brake calipers at 520 and 550 will control the shuffling caliper yaw actuation and braking system to provide counter-clockwise nacelle rotation.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A yaw actuation and braking system for controlling a yaw position of a wind turbine nacelle with respect to a tower, comprising:
a brake rotor rigidly connected to one of the tower and the nacelle;
a first brake caliper disposed to selectively close upon the brake rotor; and
a first linear actuator coupled between the first brake caliper and the other of the tower and the nacelle.

2. The yaw actuation and braking system of claim 1, wherein
extending the first linear actuator while the first brake caliper is closed upon the brake rotor causes corresponding rotation of the nacelle with respect to the tower in a first direction, and
retracting the first linear actuator while the first brake caliper is closed upon the brake rotor causes corresponding rotation of the nacelle in a second direction opposite to the first direction.

3. The yaw actuation and braking system of claim 1, further comprising:
a second brake caliper disposed to selectively close upon the brake rotor; and
a second linear actuator coupled between the second brake caliper and the other of the tower and the nacelle.

4. The yaw actuation and braking system of claim 3, further comprising:
a controller to control the first and second brake calipers and the first and second linear actuators, the controller configured to cause the nacelle to rotate with respect to the tower by opening and closing the first brake caliper and the second brake caliper alternately while alternately extending and retracting each of the first and second linear actuators.

5. The yaw actuation and braking system of claim 4, wherein the controller is further configured to:
determine a desired nacelle yaw position based on wind data, and
control the first and second brake calipers and the first and second linear actuators to cause the nacelle to rotate to the desired yaw position.

6. The yaw actuation and braking system of claim 5, wherein the controller is further configured to:
close both the first and second brake calipers during periods when nacelle rotation is not required.

7. The yaw actuation and braking system of claim 3, wherein the first linear actuator and the second linear actuator comprise hydraulic cylinders.

8. The yaw actuation and braking system of claim 1, wherein the brake rotor is rigidly connected to the tower and the first linear actuator is coupled between the first brake caliper and a structural element of the nacelle.

9. The yaw actuation and braking system of claim 1, wherein the brake rotor is rigidly connected to a structural element of the nacelle and the first linear actuator is coupled between the first brake caliper and the tower.

10. A method for controlling a yaw position of a wind turbine nacelle with respect to a tower, comprising:
closing a first brake caliper upon a brake rotor, the brake rotor rigidly connected to one of the tower and the nacelle; and
extending or retracting a first linear actuator coupled between the first brake caliper and the other of the tower and the nacelle.

11. The method of claim 10, wherein
extending the first linear actuator while the first brake caliper is closed upon the brake rotor causes corresponding rotation of the nacelle with respect to the tower in a first direction, and
retracting the first linear actuator while the first brake caliper is closed upon the brake rotor causes corresponding rotation of the nacelle in a second direction opposite to the first direction.

12. The method of claim 10, further comprising:
opening and closing the first brake caliper and a second brake caliper alternately; and
alternately extending and retracting each of the first linear actuator and a second linear actuator coupled between the second brake caliper and the other of the tower and the nacelle.

13. The method of claim 12, further comprising:
determining a desired nacelle yaw position based on wind data, and
controlling the first and second brake calipers and the first and second linear actuators to cause the nacelle to rotate to the desired yaw position.

14. The method of claim 12, further comprising:
closing both the first and second brake calipers during periods when nacelle rotation is not required.

15. The method of claim 12, wherein the first linear actuator and the second linear actuator comprise hydraulic cylinders.

16. The method of claim 10, wherein the brake rotor is rigidly connected to the tower and the first linear actuator is coupled between the first brake caliper and a structural element of the nacelle.

17. The method of claim 10, wherein the brake rotor is rigidly connected to a structural element of the nacelle and the first linear actuator is coupled between the first brake caliper and the tower.
